(19) United States
(12) Patent Application Publication
(10) Pub. No.: US 2025/0076582 A1
(43) Pub. Date: Mar. 6, 2025

(54) ASYMMETRIC WAVELENGTH MULTIPLEXING AND DEMULTIPLEXING CHIP BASED ON INVERSE DESIGN

(71) Applicants: NANJING XIGUANG RESEARCH INSTITUTE FOR INFORMATION TECHNOLOGY CO., LTD, Jiangsu (CN); WUXI TACLINK OPTOELECTRONICS TECHNOLOGY CO., LTD., Jiangsu (CN); Southeast University, Jiangsu (CN)

(72) Inventors: Weifeng JIANG, Jiangsu (CN); Xiaohan SUN, Jiangsu (CN); Xuekang SHAN, Jiangsu (CN); Sang GUI, Jiangsu (CN); Ronghua CHI, Jiangsu (CN); Lei WANG, Jiangsu (CN); Xianqin LI, Jiangsu (CN)

(73) Assignees: NANJING XIGUANG RESEARCH INSTITUTE FOR INFORMATION TECHNOLOGY CO., LTD, Jiangsu (CN); WUXI TACLINK OPTOELECTRONICS TECHNOLOGY CO., LTD., Jiangsu (CN); Southeast University, Jiangsu (CN)

(21) Appl. No.: 18/563,384

(22) PCT Filed: Aug. 23, 2022
(86) PCT No.: PCT/CN2022/114224

§ 371 Date: Nov. 22, 2023

(30) Foreign Application Priority Data
Aug. 22, 2022 (CN) 202211006611.8

(51) Int. Cl. G02B 6/293; G02B 27/00

(52) U.S. Cl. CPC G02B 6/2938; G02B 27/0012

(57) ABSTRACT

The present disclosure discloses an asymmetric wavelength multiplexing and demultiplexing chip based on inverse design, which belongs to the technical field of optical components, systems or instrument. The chip includes the first-level asymmetric wavelength multiplexing and demultiplexing unit and the second-level symmetric wavelength multiplexing and demultiplexing unit, which is constructed by silicon based photonics integration technology, includes a substrate, a bottom cladding layer, a core layer and a top cladding layer sequentially stacked from bottom to top. The functional regions inside the first-level unit and the second-level unit are designed based on the inverse design algorithms, and are composed of subunits on the submicron or nanometer scale. The chip provided is capable of covering the all-band in the optical communication system, and implementing the non-uniform wavelength division of the energy across all-band; and has an ultra-compact structure, adjustable wavelength intervals, non-uniform transmittance of each wavelength, low channel interval crosstalk.

### TECHNICAL FIELD

The present disclosure discloses an asymmetric wavelength multiplexing and demultiplexing chip based on the inverse design, relates to the optical communication and integrated optoelectronic device technology, and belongs to the technical field of optical components, systems or instruments.

### BACKGROUND

With the rapid increase of high-definition data flows on the Internet, the demand for the communication capacity from user terminals has shown a great growth trend. In the past few decades, optical communication systems have made important contributions to the improvement of the communication capacity. The invention and widespread commercial use of Wavelength Division Multiplexing (WDM) technology satisfy people's demand for data flows. The band used by the traditional WDM system is concentrated in the C-band, which is difficult to satisfy the future communication requirements. In order to further increase the system capacity, the optical communication system have to expand the available bands to O+E+S+C+L bands, and implement the technical solutions of all-band WDM.

In order to construct an all-band WDM system, it is necessary to study the corresponding all-band wavelength multiplexing and demultiplexing chip. The traditional wavelength multiplexing and demultiplexing chips are generally limited to the C-band, which is difficult to cover the O+E+S+L bands. Due to the existence of “water peak” inside the optical fiber, the transmission loss of the optical fiber is non-uniform and nonlinear in the O+E+S+C+L bands, especially in the E band there is a high transmission loss “water peak”. In order to implement the function of multiplexing and demultiplexing wavelength with non-uniform transmittance of output waveguides, it is necessary to propose an all-band asymmetric wavelength multiplexing and demultiplexing technology, which is capable of finely adjusting the output characteristics for each wavelength to implement non-uniform output across all bands.

At present, most of the asymmetric wavelength multiplexing and demultiplexing technologies are based on thin-film devices, which have relatively large volumes, poor stability and poor wavelength expansion. In order to further improve the performance of the asymmetric wavelength multiplexing and demultiplexing, the asymmetric wavelength multiplexing and demultiplexing chip based on photonics integration technology has become a new choice. Silicon-based photonics integration chip has high photoelectric performance, compact size and low cost, and is compatible with the manufacturing process of the Complementary Metal Oxide Semiconductor (CMOS). However, the implementation of high-performance asymmetric wavelength multiplexing and demultiplexing chip is limited by the dispersion problem of the silicon-based photonics integration technology. The traditional silicon-based photonics integration technology based on forward design is limited by its structural principle, and cannot implement the ultra-small large-scale optoelectronic devices.

In recent years, photonic integrated devices based on inverse design have been proposed successively, which can implement higher integrated wavelength division multiplexing devices, ultra-compact resonators, and mode multiplexing devices. However, at present, the number of channels of photonic integrated devices based on inverse design is generally little, which cannot implement the function of multi-channel asymmetric wavelength multiplexing and demultiplexing. Therefore, it is necessary to propose a new type of asymmetric wavelength multiplexing and demultiplexing chip based on the inverse design to solve the above problems.

### SUMMARY OF INVENTION

The objectives of the present disclosure are to provide an asymmetric wavelength multiplexing and demultiplexing chip based on inverse design in view of the deficiencies of the above background technology. Through the inverse design and silicon-based photonics integration technology, an asymmetric wavelength multiplexing and demultiplexing chip with high integration and stable performance is implemented, and the objective of the present disclosure of all-band transmittance or non-uniform output at wavelength intervals is implemented, and the signal transmission density is improved, the fiber utilization rate is increased, the transmission distance is extended. The technical problems such as large volume, poor stability and poor wavelength expansion of thin-film type asymmetric wavelength multiplexing and demultiplexing chip are solved.

The following technical solutions are adopted in the present disclosure to realize the above objectives.

The asymmetric wavelength multiplexing and demultiplexing chip based on the inverse design comprises a first-level asymmetric wavelength multiplexing and demultiplexing unit and at least N second-level symmetric wavelength multiplexing and demultiplexing units, and the first-level asymmetric wavelength multiplexing and demultiplexing unit includes one input waveguide and at least N+M output waveguides. A set of optical signals with different wavelengths are input into an input waveguide of the first-level asymmetric wavelength multiplexing and demultiplexing unit, a set of optical signals with different wavelengths but same transmittance are output from N output waveguides of the first-level asymmetric wavelength multiplexing and demultiplexing unit respectively to a second-level symmetric wavelength multiplexing and demultiplexing unit, and one optical signal in the M optical signals with different transmittance is output from M output waveguides of the first-level asymmetric wavelength multiplexing and demultiplexing unit respectively, both N and M are integers greater than or equal to 1.

Optionally, one of the M output waveguides in the first-level asymmetric wavelength multiplexing and demultiplexing unit is accessed to a N+1-th second-level symmetric wavelength multiplexing and demultiplexing unit, at least two of the M optical signals with different transmittances are transmitted to an input waveguide of the N+1-th second-level symmetric wavelength multiplexing and demultiplexing unit through one of the M output waveguides of the first-level asymmetric wavelength multiplexing and demultiplexing unit, and at least two of the M optical signals with different transmittances are wavelength division output by an output waveguide of the N+1-th second-level symmetric wavelength multiplexing and demultiplexing unit.

Optionally, at least one of the N output waveguides of the first-level asymmetric wavelength multiplexing and demultiplexing unit is accessed to an input waveguide of third-level symmetric wavelength multiplexing and demultiplexing units, part of the set of optical signals with different wavelengths but same transmittance output by one output waveguide of the N output waveguides of the first-level asymmetric wavelength multiplexing and demultiplexing unit are transmitted to one third-level symmetric wavelength multiplexing and demultiplexing unit, and part of the set of optical signals with different wavelengths but same transmittance are output by the third-level symmetric wavelength multiplexing and demultiplexing unit through wavelength division.

Functional regions inside the first-level asymmetric wavelength multiplexing and demultiplexing unit, the second-level symmetric wavelength multiplexing and demultiplexing unit and the third-level symmetric wavelength multiplexing and demultiplexing unit are designed based on inverse design, and the functional regions are composed of subunits on the submicron or nanometer scale.

The inverse design algorithm, such as Direct Binary Search (DBS), is utilized to optimize the design on the functional regions of the first-level asymmetric wavelength multiplexing and demultiplexing unit, the second-level symmetric wavelength multiplexing and demultiplexing unit and the third-level symmetric wavelength multiplexing and demultiplexing unit. The three functional regions are rectangular and a plurality of sub-wavelength units are introduced internally. Each sub-wavelength unit can be made of silicon dioxide or Silicon, or silicon dioxide or doped silicon dioxide, corresponding to the Silicon-On-Insulator (SOI) platform and Silica-On-Silicon (SoS) platform on the nonconductor, respectively. Firstly, the material type of the sub-wavelength unit is randomly set; then the FOM of the functional regions are given as follows.

$$FOM = FOM ( {O}_{1} ) + … + F OM ( {O}_{m + p} ) + … + F OM ( {O}_{m + p + q + 1} ) + F OM ( {O}_{m + p + q + 2} ) + … F OM ( {O}_{m + p + q + r} ) + F OM ( {O}_{m + p + q + s + 1} ) + … + F OM ( {O}_{m + p + q + s + w} ) ,$$

$$where$$

$$FOM ( {O}_{1} ) = \frac{1}{\vert \frac{{T}_{{λ}_{1} , {O}_{1}}}{{T}_{{λ}_{1} , in}} - {IL}_{{O}_{1}} \vert} + \frac{1}{\vert \frac{{T}_{{λ}_{2} , {O}_{1}}}{{T}_{{λ}_{2} , in}} - {IL}_{{O}_{1}} \vert} + … + \frac{1}{\vert \frac{{T}_{{λ}_{m} , {O}_{1}}}{{T}_{{λ}_{m} , in}} - {IL}_{{O}_{1}} \vert} ,$$

$$FOM ( {O}_{m + p} ) = \frac{1}{\vert \frac{{T}_{{λ}_{m + p} , {O}_{m + p}}}{{T}_{{λ}_{m + p} , in}} - {IL}_{{O}_{m + p}} \vert} + \frac{1}{\vert \frac{{T}_{{λ}_{m + p + 1} , {O}_{m + p}}}{{T}_{{λ}_{m + p + 1} , in}} - {IL}_{{O}_{m + p}} \vert} + … + \frac{1}{\vert \frac{{T}_{{λ}_{m + p + q} , {O}_{m + p}}}{{T}_{{λ}_{m + p + q} , in}} - {IL}_{{O}_{m + p}} \vert} ,$$

$$FOM ( {O}_{m + p + q + 1} ) = \frac{1}{\vert \frac{{T}_{{λ}_{m + p + q + 1} , {O}_{m + p + q + 1}}}{{T}_{{λ}_{m + p + q + 1} , in}} - {IL}_{{O}_{m + p + q + 1}} \vert} ,$$

$$FOM ( {O}_{m + p + q + 2} ) = \frac{1}{\vert \frac{{T}_{{λ}_{m + p + q + 2} , {O}_{m + p + q + 2}}}{{T}_{{λ}_{m + p + q + 2} , in}} - {IL}_{{O}_{m + p + q + 2}} \vert} ,$$

$$FOM ( {O}_{m + p + q + r} ) = \frac{1}{\vert \frac{{T}_{{λ}_{m + p + q + r} , {O}_{m + p + q + r}}}{{T}_{{λ}_{m + p + q + r} , in}} - {IL}_{{O}_{m + p + q + r}} \vert} + \frac{1}{\vert \frac{{T}_{{λ}_{m + p + q + r + 1} , {O}_{m + p + q + r}}}{{T}_{{λ}_{m + p + q + r + 1} , in}} - {IL}_{{O}_{m + p + q + r}} \vert} + … + \frac{1}{\vert \frac{{T}_{{λ}_{m + p + q + s} , {O}_{m + p + q + r}}}{{T}_{{λ}_{m + p + q + s} , in}} - {IL}_{{O}_{m + p + q + r}} \vert} ,$$

$$FOM ( {O}_{m + p + q + s + 1} ) = \frac{1}{\vert \frac{{T}_{{λ}_{m + p + q + s + 1} , {O}_{m + p + q + s + 1}}}{{T}_{{λ}_{m + p + q + s + 1} , in}} - {IL}_{{O}_{m + p + q + s + 1}} \vert} + \frac{1}{\vert \frac{{T}_{{λ}_{m + p + q + s + 2} , {O}_{m + p + q + s + 1}}}{{T}_{{λ}_{m + p + q + s + 2} , in}} - {IL}_{{O}_{m + p + q + s + 1}} \vert} + … + \frac{1}{\vert \frac{{T}_{{λ}_{m + p + q + s + t} + q , {O}_{m + p + q + s + 1}}}{{T}_{{λ}_{m + p + q + s + t} , in}} - {IL}_{{O}_{m + p + q + s + 1}} \vert} ,$$

$$FOM ( {O}_{m + p + q + s + w} ) = \frac{1}{\vert \frac{{T}_{{λ}_{m + p + q + s + t + w} , {O}_{m + p + q + s + w}}}{{T}_{{λ}_{m + p + q + s + w} , in}} - {IL}_{{O}_{m + p + q + s + w}} \vert} + \frac{1}{\vert \frac{{T}_{{λ}_{m + p + q + s + t + w + 1} , {O}_{m + p + q + s + w}}}{{T}_{{λ}_{m + p + q + s + w + 1} , in}} - {IL}_{{O}_{m + p + q + s + w}} \vert} + … + \frac{1}{\vert \frac{{T}_{{λ}_{n - v} , {O}_{m + p + q + s + w}}}{{T}_{{λ}_{n - v} , in}} - {IL}_{{O}_{m + p + q + s + w}} \vert} + \frac{1}{\vert \frac{{T}_{{λ}_{n - v + 1} , {O}_{m + p + q + s + w}}}{{T}_{{λ}_{n - v + 1} , in}} - {IL}_{{O}_{m + p + q + s + w}} \vert} … + \frac{1}{\vert \frac{{T}_{{λ}_{n} , {O}_{m + p + q + s + w}}}{{T}_{{λ}_{n} , in}} - {IL}_{{O}_{m + p + q + s + w}} \vert} .$$

The FOM function is a MAX function established based on a target of minimizing the difference between an actual output optical loss and a target output optical loss of each output waveguide in wavelength multiplexing and demultiplexing units. The actual output optical loss of the output waveguide in the wavelength multiplexing and demultiplexing unit is a ratio of the transmittances of the output waveguide and the input waveguide to the optical signal with same wavelength.

Subsequently, the size change of the FOM is calculated and compared by traversing each sub-wavelength unit, and the material types with larger FOMs are selectively retained. The optimal structure of the functional area is given by iterating and traversing all sub-wavelength elements repeatedly.

As a further improvement of the present disclosure, the first-level asymmetric wavelength multiplexing and demultiplexing unit is capable of implementing the wavelength division of multi-wavelength with asymmetry and different losses. Both of the second-level symmetric wavelength multiplexing and demultiplexing unit and the third-level symmetric wavelength multiplexing and demultiplexing unit are symmetric wavelength multiplexing and demultiplexing units, which are capable of implementing the wave division of multi-wavelength with equalization and equal loss.

As a further improvement of the present disclosure, all of the sizes of the functional regions of the first-level asymmetric wavelength multiplexing and demultiplexing unit, the second-level symmetric wavelength multiplexing and demultiplexing unit and the third-level symmetric wavelength multiplexing and demultiplexing unit are square microns or square millimeters scale.

As a further improvement of the present disclosure, the asymmetric wavelength multiplexing and demultiplexing chip is capable of implementing multi-wavelength division in O+E+S+C+L band, and the numbers of wavelengths can be 6, 7, 8, 9, 10, 12, 16, 18, 32, 48, 55, 64, 128, etc., and the wavelength output characteristics can be adjusted. The internal working mode of the chip can be transverse electrical mode or transverse magnetic mode, and the number of the mode order can be either fundamental mode or higher order mode.

As a further improvement of the present disclosure, the first-level asymmetric wavelength multiplexing and demultiplexing unit is accessed with the second-level symmetric wavelength multiplexing and demultiplexing unit through an S-shaped curved waveguide, and its interior can pass through multiple wavelengths with low loss.

As a further improvement of the present disclosure, all of the input waveguides of the first-level asymmetric wavelength multiplexing and demultiplexing unit, the second-level symmetric wavelength multiplexing and demultiplexing unit and the third-level symmetric wavelength multiplexing and demultiplexing unit are set in the center positions, and the output waveguides are equally distributed.

As a further improvement of the present disclosure, the asymmetric wavelength multiplexing and demultiplexing chip can be prepared in batches by semiconductor technology, based on one of platforms of silicon on insulator, silicon dioxide on silicon, InP, GaAs, polymer, Lithium Niobate (LN), diamond and chalcogenide system.

As a further improvement of the present disclosure, the structures of the functional regions of the wavelength multiplexing and demultiplexing units can be optimized based on DBS algorithm, semi-constrained algorithm, particle swarm optimization algorithm, level set algorithm, density topology optimization, basic gradient algorithm, gradient descent algorithm and genetic algorithm, and deep learning the inverse design algorithm by the asymmetric wavelength multiplexing and demultiplexing chip, which can implement designs of higher efficiency, smaller size and higher device performance.

The present disclosure has the following beneficial effects by adopting the above technical solutions.
(1) The asymmetric wavelength multiplexing and demultiplexing chip provided in the present disclosure is capable of covering the all-band (O+E+S+C+L band) in the optical communication system, and implementing the non-uniform wavelength division of the power across all-band; and based on the inverse design, the chip structure can be ultra-compact, the output wavelength intervals are adjustable, the transmittance of each wavelength is non-uniform, the channel interval crosstalk is low, the performance is stable, and the design is simple.
(2) The asymmetric wavelength multiplexing and demultiplexing chip provided in the present disclosure has strong expansibility, thereby implementing an arbitrary selection of two wavelengths to multi-wavelength; and the evaluation functions with simple design is capable of implementing the efficient optimization design of ultra-compact chips; and the function of the asymmetric wavelength multiplexing and demultiplexing with multi-channel and multi-wavelength can be implemented through the cascaded structure of the asymmetric wavelength multiplexing and demultiplexing unit and the symmetric wavelength multiplexing and demultiplexing unit.
(3) The functional regions of the wavelength multiplexing and demultiplexing units are prepared by silicon materials in the asymmetric wavelength multiplexing and demultiplexing chip provided in the present disclosure, thereby the chip provided can be prepared on a large scale based on a mature semiconductor process.

### BRIEF DESCRIPTION OF DRAWINGS

FIG. 1 illustrates a topology structural schematic diagram of the asymmetric wavelength multiplexing and demultiplexing chip in the present disclosure.

FIG. 2 illustrates a specific structural schematic diagram of the asymmetric wavelength multiplexing and demultiplexing chip in Embodiment 1 of the present disclosure.

FIG. 3 illustrates a structural schematic diagram of the first-level asymmetric wavelength multiplexing and demultiplexing unit in Embodiment 1 of the present disclosure.

FIG. 4 illustrates a structural schematic diagram of the second-level symmetric wavelength multiplexing and demultiplexing unit 002 in Embodiment 1 of the present disclosure.

FIG. 5 illustrates a structural schematic diagram of the second-level symmetric wavelength multiplexing and demultiplexing unit 006 in Embodiment 1 of the present disclosure.

FIG. 6 illustrates an output spectrum diagram of the asymmetric wavelength multiplexing and demultiplexing chip in Embodiment 1 of the present disclosure.

FIG. 7 illustrates a specific structural schematic diagram of the asymmetric wavelength multiplexing and demultiplexing chip in Embodiment 2 of the present disclosure.

FIG. 8 illustrates an output spectrum diagram of the asymmetric wavelength multiplexing and demultiplexing chip in Embodiment 2 of the present disclosure.

Reference numbers in the drawings: 001 represents the first-level asymmetric wavelength multiplexing and demultiplexing unit, 002, 004, 005, 006 and 007 represent the second-level symmetric wavelength multiplexing and demultiplexing units, 003 and 008 represent the third-level symmetric wavelength multiplexing and demultiplexing units, 101 represents the input waveguide of the first-level asymmetric wavelength multiplexing and demultiplexing unit, 102 represents the functional area of the first-level asymmetric wavelength multiplexing and demultiplexing unit, 103 to 106 represent the output waveguides of the first-level asymmetric wavelength multiplexing and demultiplexing unit, 201 represents the input waveguide of the second-level symmetric wavelength multiplexing and demultiplexing unit 002, 202 represents the functional area of the second-level symmetric wavelength multiplexing and demultiplexing unit 002, 203 to 206 represent the output waveguides of the second-level symmetric wavelength multiplexing and demultiplexing unit 002, 601 represents the input waveguide of the second-level symmetric wavelength multiplexing and demultiplexing unit 006, 602 represents the functional area of the second-level symmetric wavelength multiplexing and demultiplexing unit 006, 603 to 608 represent the output waveguides of the second-level symmetric wavelength multiplexing and demultiplexing unit 006.

### DESCRIPTION OF EMBODIMENTS

In order to enable the objectives, the technical solutions and the advantages of the present disclosure to be clearer, the present disclosure is detailed elucidated below in conjunction with the drawings and specific embodiments.

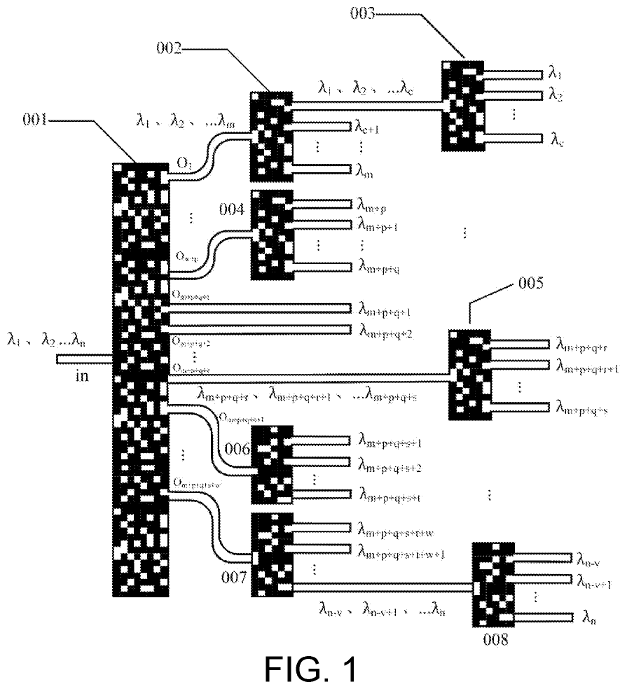

According to the transmittances of the output waveguide to n wavelength optical signals λₗ to λₙ, the n wavelength optical signals λₗ to λₙ are divided into multiple sets of the optical signals with uniform transmittance and the optical signals with significant differences from the uniform transmittance, then the multiple sets of the optical signals with uniform transmittance are output from a symmetric wavelength combining and dividing unit respectively, and the optical signals with significant differences from the uniform transmittance are output from the output waveguide of the asymmetric wavelength multiplexing and demultiplexing unit respectively or are output through wavelength division after passing the symmetric wavelength multiplexing and demultiplexing unit. The general topology of the asymmetric wavelength multiplexing and demultiplexing chip provided in the present disclosure is as illustrated in FIG. 1, comprises: the first-level asymmetric wavelength multiplexing and demultiplexing unit 001, the second-level symmetric wavelength multiplexing and demultiplexing unit 002, the second-level symmetric wavelength multiplexing and demultiplexing unit 004, the second-level symmetric wavelength multiplexing and demultiplexing unit 005, the second-level symmetric wavelength multiplexing and demultiplexing unit 006, the second-level symmetric wavelength multiplexing and demultiplexing unit 007, the third-level symmetric wavelength multiplexing and demultiplexing unit 003, the third-level symmetric wavelength multiplexing and demultiplexing unit 008. The n wavelength optical signals λₗ to λₙ are input from the input waveguide of the first-level asymmetric wavelength multiplexing and demultiplexing unit 001, the input waveguides of the second-level symmetric wavelength multiplexing and demultiplexing unit 002, the second-level symmetric wavelength multiplexing and demultiplexing unit 004, the second-level symmetric wavelength multiplexing and demultiplexing unit 006 and the second-level symmetric wavelength multiplexing and demultiplexing unit 007 are accessed to one output waveguide of the first-level asymmetric wavelength multiplexing and demultiplexing unit 001 respectively. A set of optical signals with different wavelengths but same transmittance are output by the second-level symmetric wavelength multiplexing and demultiplexing unit 002, the second-level symmetric wavelength multiplexing and demultiplexing unit 004, the second-level symmetric wavelength multiplexing and demultiplexing unit 006 and the second-level symmetric wavelength multiplexing and demultiplexing unit 007 respectively, such as, a set of optical signals with wavelengths λ₁, λ₂ . . . λₘ are transmitted to the second-level symmetric wavelength multiplexing and demultiplexing unit 002 through the first output waveguide O₁ of the first-level asymmetric wavelength multiplexing and demultiplexing unit 001, a set of optical signals with wavelengths λₘ₊ₚ, λₘ₊ₚ₊₁ . . . λ_{m+p+q} are transmitted to the second-level symmetric wavelength multiplexing and demultiplexing unit 004 through the m+p-th output waveguide Oₘ₊ₚ of the first-level asymmetric wavelength multiplexing and demultiplexing unit 001, a set of optical signals with wavelengths λ_{m+p+q+s+1}, λ_{m+p+q++s+2} . . . λ_{m+p+q+s+t} are transmitted to the second-level symmetric wavelength multiplexing and demultiplexing unit 006 through the m+p+q+s+1-th output waveguide O_{m+p+q+s+1} of the first-level asymmetric wavelength multiplexing and demultiplexing unit 001, a set of optical signals with wavelengths λ_{m+p+q+s++t +w}, λ_{m+p+q++s +t +w++1} . . . λₙ₋ᵥ₊₁ . . . λₙ are transmitted to the second-level symmetric wavelength multiplexing and demultiplexing unit 007 through the m+p+q+s+w-th output waveguide O_{m+p+q+s++w} of the first-level asymmetric wavelength multiplexing and demultiplexing unit 001. The optical signals of the remaining wavelengths are respectively output by other output waveguides of the first-level asymmetric wavelength multiplexing and demultiplexing unit 001 or sent to the second-level symmetric wavelength multiplexing and demultiplexing unit 005 for the wavelength-division processing, and then output respectively, such as, the optical signal with a wavelength λ_{m+p+q+1} is output directly through the m+p+q+1-th output waveguide O_{m+p+q+1} of the first-level asymmetric wavelength multiplexing and demultiplexing unit 001, the optical signal with a wavelengthλ_{m +p+q+2} is output directly through the m+p+q+2-th output waveguide O_{m+p+q+2} of the first-level asymmetric wavelength multiplexing and demultiplexing unit 001, a set of optical signals with wavelengths λ_{m+p+q+r}, λ_{m+p+q+r+1} . . . λ_{m+p+q+s} are transmitted to the second-level symmetric wavelength multiplexing and demultiplexing unit 005 through the m+p+q+r output waveguide O_{m+p+q+r} of the first-level asymmetric wavelength multiplexing and demultiplexing unit 001. The third-level symmetric wavelength multiplexing and demultiplexing unit 003 and the third-level symmetric wavelength multiplexing and demultiplexing unit 008 are accessed after the second-level symmetric wavelength multiplexing and demultiplexing unit 002 and the second-level symmetric wavelength multiplexing and demultiplexing unit 007 respectively, and a set of optical signals with wavelengths λ₁, λ₂ . . . λ_{c} are output through wavelength division by the third-level symmetric wavelength multiplexing and demultiplexing unit 003, a set of optical signals with wavelengths λₙ₋ᵥ, λₙ₋ᵥ₊₁ . . . λₙ are output through wavelength division by the third-level symmetric wavelength multiplexing and demultiplexing unit 008. Optionally, the forth-level symmetric wavelength multiplexing and demultiplexing unit is accessed after the third-level symmetric wavelength multiplexing and demultiplexing unit, the asymmetric wavelength multiplexing and demultiplexing with multi-channel and multi-wavelength can be implemented by the cascaded structure of the asymmetric wavelength multiplexing and demultiplexing unit and the symmetric wavelength multiplexing and demultiplexing unit.

After the general topology of the asymmetric wavelength multiplexing and demultiplexing chip as illustrated in FIG. 1 is determined, the functional regions of the first-level asymmetric wavelength multiplexing and demultiplexing unit, the second-level symmetric wavelength multiplexing and demultiplexing unit and the third-level symmetric wavelength multiplexing and demultiplexing unit need to be optimally designed through inverse design algorithm such as Direct Binary Search (DBS) algorithm. Each functional area is rectangular and a plurality of sub-wavelength units are introduced internally. Each sub-wavelength unit can be made of silicon dioxide or Silicon, or silicon dioxide or doped silicon dioxide, corresponding to the Silicon-On-Insulator (SOI) platform and Silica-On-Silicon (SoS) platform on the nonconductor, respectively.

Firstly, the material type of each sub-wavelength unit in the first-level asymmetric wavelength multiplexing and demultiplexing unit is randomly set; then the evaluation function FOM of the first-level asymmetric wavelength multiplexing and demultiplexing unit is given; subsequently the sub-wavelength units of the first-level asymmetric wavelength multiplexing and demultiplexing unit are traversed with the objective of maximizing FOM and the material type of each sub-wavelength unit with the largest FOM is selected. The design ideas of the functional area of the second-level symmetric wavelength multiplexing and demultiplexing unit and the third-level symmetric wavelength multiplexing and demultiplexing unit are the same as the first-level asymmetric wavelength multiplexing and demultiplexing unit, which will not repeated in the present disclosure.

The evaluation function FOM of the first-level asymmetric wavelength multiplexing and demultiplexing unit is:

$$FOM = FOM ( {O}_{1} ) + … + F OM ( {O}_{m + p} ) + … + F OM ( {O}_{m + p + q + 1} ) + F OM ( {O}_{m + p + q + 2} ) + … F OM ( {O}_{m + p + q + r} ) + F OM ( {O}_{m + p + q + s + 1} ) + … + F OM ( {O}_{m + p + q + s + w} ) ,$$

$$FOM ( {O}_{1} ) = \frac{1}{\vert \frac{{T}_{{λ}_{1} , {O}_{1}}}{{T}_{{λ}_{1} , in}} - {IL}_{{O}_{1}} \vert} + \frac{1}{\vert \frac{{T}_{{λ}_{2} , {O}_{1}}}{{T}_{{λ}_{2} , in}} - {IL}_{{O}_{1}} \vert} + … + \frac{1}{\vert \frac{{T}_{{λ}_{m} , {O}_{1}}}{{T}_{{λ}_{m} , in}} - {IL}_{{O}_{1}} \vert} ,$$

$$FOM ( {O}_{m + p} ) = \frac{1}{\vert \frac{{T}_{{λ}_{m + p} , {O}_{m + p}}}{{T}_{{λ}_{m + p} , in}} - {IL}_{{O}_{m + p}} \vert} + \frac{1}{\vert \frac{{T}_{{λ}_{m + p + 1} , {O}_{m + p}}}{{T}_{{λ}_{m + p + 1} , in}} - {IL}_{{O}_{m + p}} \vert} + … + \frac{1}{\vert \frac{{T}_{{λ}_{m + p + q} , {O}_{m + p}}}{{T}_{{λ}_{m + p + q} , in}} - {IL}_{{O}_{m + p}} \vert} ,$$

$$FOM ( {O}_{m + p + q + 1} ) = \frac{1}{\vert \frac{{T}_{{λ}_{m + p + q + 1} , {O}_{m + p + q + 1}}}{{T}_{{λ}_{m + p + q + 1} , in}} - {IL}_{{O}_{m + p + q + 1}} \vert} ,$$

$$FOM ( {O}_{m + p + q + 2} ) = \frac{1}{\vert \frac{{T}_{{λ}_{m + p + q + 2} , {O}_{m + p + q + 2}}}{{T}_{{λ}_{m + p + q + 2} , in}} - {IL}_{{O}_{m + p + q + 2}} \vert} ,$$

$$FOM ( {O}_{m + p + q + r} ) = \frac{1}{\vert \frac{{T}_{{λ}_{m + p + q + r} , {O}_{m + p + q + r}}}{{T}_{{λ}_{m + p + q + r} , in}} - {IL}_{{O}_{m + p + q + r}} \vert} + \frac{1}{\vert \frac{{T}_{{λ}_{m + p + q + r + 1} , {O}_{m + p + q + r}}}{{T}_{{λ}_{m + p + q + r + 1} , in}} - {IL}_{{O}_{m + p + q + r}} \vert} + … + \frac{1}{\vert \frac{{T}_{{λ}_{m + p + q + s} , {O}_{m + p + q + r}}}{{T}_{{λ}_{m + p + q + s} , in}} - {IL}_{{O}_{m + p + q + r}} \vert} ,$$

$$FOM ( {O}_{m + p + q + s + 1} ) = \frac{1}{\vert \frac{{T}_{{λ}_{m + p + q + s + 1} , {O}_{m + p + q + s + 1}}}{{T}_{{λ}_{m + p + q + s + 1} , in}} - {IL}_{{O}_{m + p + q + s + 1}} \vert} + \frac{1}{\vert \frac{{T}_{{λ}_{m + p + q + s + 2} , {O}_{m + p + q + s + 1}}}{{T}_{{λ}_{m + p + q + s + 2} , in}} - {IL}_{{O}_{m + p + q + s + 1}} \vert} + … + \frac{1}{\vert \frac{{T}_{{λ}_{m + p + q + s + t} + q , {O}_{m + p + q + s + 1}}}{{T}_{{λ}_{m + p + q + s + t} , in}} - {IL}_{{O}_{m + p + q + s + 1}} \vert} ,$$

$$FOM ( {O}_{m + p + q + s + w} ) = \frac{1}{\vert \frac{{T}_{{λ}_{m + p + q + s + t + w} , {O}_{m + p + q + s + w}}}{{T}_{{λ}_{m + p + q + s + w} , in}} - {IL}_{{O}_{m + p + q + s + w}} \vert} + \frac{1}{\vert \frac{{T}_{{λ}_{m + p + q + s + t + w + 1} , {O}_{m + p + q + s + w}}}{{T}_{{λ}_{m + p + q + s + w + 1} , in}} - {IL}_{{O}_{m + p + q + s + w}} \vert} + … + \frac{1}{\vert \frac{{T}_{{λ}_{n - v} , {O}_{m + p + q + s + w}}}{{T}_{{λ}_{n - v} , in}} - {IL}_{{O}_{m + p + q + s + w}} \vert} + \frac{1}{\vert \frac{{T}_{{λ}_{n - v + 1} , {O}_{m + p + q + s + w}}}{{T}_{{λ}_{n - v + 1} , in}} - {IL}_{{O}_{m + p + q + s + w}} \vert} … + \frac{1}{\vert \frac{{T}_{{λ}_{n} , {O}_{m + p + q + s + w}}}{{T}_{{λ}_{n} , in}} - {IL}_{{O}_{m + p + q + s + w}} \vert} ,$$

where FOM(O₁) represents an evaluation function for transmittances T_{λ}_{₁}_{,O}_{₁}, T_{λ}_{₂}_{,O}_{₁} . . . T_{λ}_{ₘ}_{,O}_{₁} of a first output waveguide O₁ of the first-level asymmetric wavelength multiplexing and demultiplexing unit to a set of optical signals with wavelengths λ₁, λ₂ . . . λₘ, T_{λ}_{₁}_{,in}, T_{λ}_{₂}_{,in} . . . T_{λ}_{ₘ}_{,in} represent transmittances of input waveguides of the first-level asymmetric wavelength multiplexing and demultiplexing unit to the set of optical signals with wavelengths λ₁, λ₂ . . . λₘ, IL_{O}_{₁} represents a target output optical loss of the first output waveguide O₁ of the first-level asymmetric wavelength multiplexing and demultiplexing unit; FOM(Oₘ₊ₚ) represents an evaluation function for transmittances T_{λ}_{ₘ₊ₚ}_{,O}_{ₘ₊ₚ}, T_{λ}_{ₘ₊ₚ₊₁}_{,O}_{ₘ₊ₚ} . . . T_{λ}_{_{m+p+q}}_{,O}_{ₘ₊ₚ} of the m+p-th output waveguide Oₘ₊ₚ of the first-level asymmetric wavelength multiplexing and demultiplexing unit to a set of optical signals with wavelengths λₘ₊ₚ, λₘ₊ₚ₊₁ . . . λ_{m+p+q}, T_{λ}_{ₘ₊ₚ}_{,in}, T_{λ}_{ₘ₊ₚ₊₁}_{,in} . . . T_{λ}_{_{m+p+q}}_{,in} represent transmittances of the input waveguides of the first-level asymmetric wavelength multiplexing and demultiplexing unit to the set of optical signals with wavelengths λₘ₊ₚ, λₘ₊ₚ₊₁ . . . λ_{m+p+q}, IL_{O}_{ₘ₊ₚ} represents a target output optical loss of the m+p-th output waveguide Oₘ₊ₚ of the first-level asymmetric wavelength multiplexing and demultiplexing unit; FOM(O_{m+p+q+1}) represents an evaluation function for a transmittance T_{λ}_{_{m+p+q+1}}_{,O}_{_{m+p+q+1}} of the m+p+q+1-th output waveguide O_{m+p+q+1} of the first-level asymmetric wavelength multiplexing and demultiplexing unit to optical signals with a wavelength λ_{m+p+q+1}, T_{λ}_{_{m+p+q+1}}_{,in} represents a transmittance of the input waveguide of the first-level asymmetric wavelength multiplexing and demultiplexing unit to the optical signals with the wavelength λ_{m+p+q+1}, IL_{O}_{_{m+p+q+1}} represents a target output optical loss of the m+p+q+1-th output waveguide O_{m+p+q+1} of the first-level asymmetric wavelength multiplexing and demultiplexing unit; FOM(O_{m+p+q+2}) represents an evaluation function for a transmittance T_{λ}_{_{m+p+q+2}}_{,O}_{_{m+p+q+2}} of the m+p+q+2-th output waveguide O_{m+p+q+2} of the first-level asymmetric wavelength multiplexing and demultiplexing unit to optical signals with a wavelength λ_{m+p+q+2}, T_{λ}_{_{m+p+q+2}}_{,in} represents a transmittance of the input waveguide of the first-level asymmetric wavelength multiplexing and demultiplexing unit to the optical signals with a wavelength λ_{m+p+q+2}, IL_{O}_{_{m+p+q+2}} represents a target output optical loss of the m+p+q+2-th output waveguide O_{m+p+q+2} of the first-level asymmetric wavelength multiplexing and demultiplexing unit; FOM(O_{m+p+q+r}) represents an evaluation function for transmittances T_{λ}_{_{m+p+q+r}}_{,O}_{_{m+p+q+r}}, T_{λ}_{_{m+p+q+r+1}}_{,O}_{_{m+p+q+r}} . . . T_{λ}_{_{m+p+q+s}}_{,O}_{_{m+p+q+r}} of the m+p+q+r-th output waveguide O_{m+p+q+r} of the first-level asymmetric wavelength multiplexing and demultiplexing unit to a set of optical signals with wavelengths λ_{m+p+q+r}, λ_{m+p+q+r+1} . . . λ_{m+p+q+s}, T_{λ}_{_{m+p+q+r}}_{,in}, T_{λ}_{_{m+p+q+r+1}}_{,in} . . . T_{λ}_{_{m+p+q+s}}_{,in} represent transmittances of the input waveguide of the first-level asymmetric wavelength multiplexing and demultiplexing unit to the set of optical signals with wavelengths λ_{m+p+q+r}, λ_{m+p+q+r+1} . . . λ_{m+p+q+s}, IL_{O}_{_{m+p+q+r}} represents a target output optical loss of the m+p+q+r-th output waveguide O_{m+p+q+r} of the first-level asymmetric wavelength multiplexing and demultiplexing unit; FOM(O_{m+p+q+s+1}) represents an evaluation function for transmittances T_{λ}_{_{m+p+q++s+1}}_{,O}_{_{m+p+q+s+1}}, T_{λm+p+q+s+1} . . . T_{λ}_{_{m+p+q+s+t}}_{,O}_{_{m+p+q+s+1}} of the m+p+q+s+1-th output waveguide O_{m+p+q+s+1} of the first-level asymmetric wavelength multiplexing and demultiplexing unit to a set of optical signals with wavelengths λ_{m+p+q+s+1}, λ_{m+p+q+s+2} . . . λ_{m+p+q+s+t}, T_{λ}_{_{m+p+q+s+1}}_{,in},T_{λ}_{_{m+p+q+s+2}}_{,in} . . . T_{λ}_{_{m+p+q+s+t}}_{,in} represent transmittances of the input waveguide of the first-level asymmetric wavelength multiplexing and demultiplexing unit to the set of optical signals with wavelengths λ_{m+p+q+s+1}, λ_{m+p+q+s+2} . . . λ_{m+p+q+s+t}, IL_{O}_{_{m+p+q+s+1}} represents a target output optical loss of the m+p+q+s+1-th output waveguide O_{m+p+q+s+1} of the first-level asymmetric wavelength multiplexing and demultiplexing unit; FOM(O_{m+p+q+s+w}) represents an evaluation function for transmittances T_{λ}_{_{m+p+q+s+t+w}}_{,O}_{_{m+p+q+s+w}} , T_{λ}_{_{m+p+q+s+t+w+1}}_{,O}_{_{m+p+q+s+w}} . . . T_{λ}_{_{n−v}}_{,O}_{_{m+p+q+s+w}}, T_{λ}_{_{n−v+1}}_{,O}_{_{m+p+q+s+w}} . . . T_{λ}_{ₙ}_{,O}_{_{m+p+q+s+w}} of an m+p+q+s+w output waveguide O_{m+p+q+s+w} of the first-level asymmetric wavelength multiplexing and demultiplexing unit to a set of optical signals with wavelengths λ_{m+p+q+s+t+w}, λ_{m+p+q+s+t+w+1} . . . λₙ₋ᵥ, λₙ₋ᵥ₊₁ . . . λₙ, T_{λ}_{_{m+p+q+s+t+w}}_{,in}, T_{λ}_{_{m+p+q+s+t+w+1}}_{,in} . . . T_{λ}_{_{n−v}}_{,in}, T_{λ}_{_{n−v+1}}_{,in} . . . T_{λ}_{ₙ}_{,in} represent transmittances of the input waveguide of the first-level asymmetric wavelength multiplexing and demultiplexing unit to the set of optical signals with wavelengths λ_{m+p+q+s+t+w}, λ_{m+p+q+s+t+w+1} . . . λₙ₋ᵥ, λₙ₋ᵥ₊₁ . . . λₙ, IL_{O}_{_{m+p+q+s+w}} represents a target output optical loss of the m+p+q+s+w-th output waveguide O_{m+p+q+s+w} of the first-level asymmetric wavelength multiplexing and demultiplexing unit. By setting the values for the positive integers c, m, p, q, r, s, t, w, and n increasing in turn, the non-uniformly adjustment of the output wavelength power and interval are implemented.

The specific embodiment 1: the asymmetric wavelength multiplexing and

demultiplexing chip for implementing non-uniform output for signal transmittances of 12 wavelengths in O+E+S+C+L band.

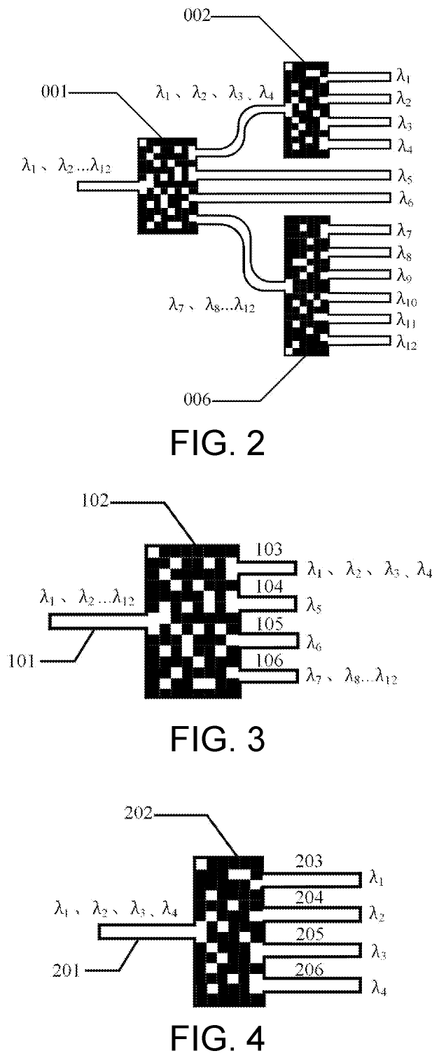

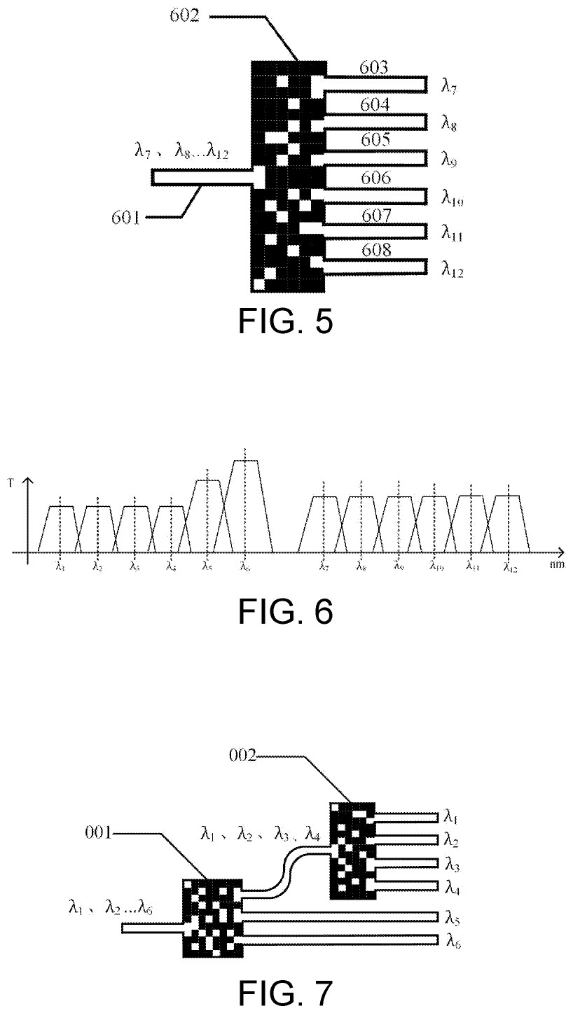

As illustrated in FIG. 2, FIG. 3, FIG. 4 and FIG. 5, the present embodiment provides an asymmetric wavelength combining and dividing chip to implement the non-uniform output for transmittances of the 12 wavelengths λ₁ to λ₁₂ in the O+E+S+C+L band. λ₁ to λ₁₂ correspond to λ₁=1271 nm, λ₂=1291 nm, λ₃=1311 nm, λ₄=1331 nm, λ₅=1351 nm, λ₆=1371 nm, λ₇=1471 nm, λ₈=1491 nm, λ₉=1511 nm, λ₁₀=1531 nm, λ₁₁=1551 nm and λ₁₂=1571 nm, λ₁ to λ₅ are located in the O band, λ₆ is located in the E band, λ₇ to λ₉ are located in the S band, λ₁₀ to λ₁₁ are located in the C band, λ₁₂ is located in the L band. The asymmetric wavelength multiplexing and demultiplexing chip is a passive device with ultra-small size and ultra-high stability.

The output spectrum diagram of the set of the optical signals with wavelengths λ₁, λ₂ . . . λ₁₂ is as illustrated in FIG. 6, as can be seen from FIG. 6, the output loss of the optical signals with four wavelengths λ₁, λ₂, λ₃, λ₄ is 2.5 dB, the output loss of the optical signals with six wavelengths λ₇, λ₈, λ₉, λ₁₀ , λ₁₁, λ₁₂ is 2 dB, and the output losses of the optical signals with wavelengths λ₅ and λ₆ are 0.9 dB and 0.6 dB, respectively. A set of optical signals with wavelengths λ₁, λ₂ . . . λ₁₂ are divided into four sets of signals through wavelength division by the first-level asymmetric wavelength multiplexing and demultiplexing unit and then output. The optical signals with wavelengths λ₁, λ₂, λ₃, λ₄ and the optical signals with wavelengths λ₇, λ₈, λ₉, λ₁₀, λ₁₁, λ₁₂ are processed through wavelength division by the second-level symmetric wavelength multiplexing and demultiplexing unit and then output. The optical signals with wavelengths λ₅, λ₆ are output by one output waveguide of the first-level asymmetric wavelength multiplexing and demultiplexing unit directly. The specific structure of the asymmetric wavelength multiplexing and demultiplexing chip for implementing the non-uniform output for transmittance of the optical signals with wavelengths λ₁, λ₂ . . . λ₁₂ is as illustrated in FIG. 2.

As illustrated in FIG. 2, the asymmetric wavelength multiplexing and demultiplexing chip for implementing the non-uniform output for transmittance of the optical signals with wavelengths λ₁, λ₂ . . . λ₁₂, includes: the first-level asymmetric wavelength multiplexing and demultiplexing unit 001, the second-level symmetric wavelength multiplexing and demultiplexing unit 002, the second-level symmetric wavelength multiplexing and demultiplexing unit 006, the first-level asymmetric wavelength multiplexing and demultiplexing unit 001 is accessed with the second-level symmetric wavelength multiplexing and demultiplexing unit 002 through an S-shaped curved waveguide, and the first-level asymmetric wavelength multiplexing and demultiplexing unit 001 is accessed with the second-level symmetric wavelength multiplexing and demultiplexing unit 006 through an S-shaped curved waveguide. The provided asymmetric wavelength multiplexing and demultiplexing chip is constructed by silicon based photonics integration technology, includes a silicon substrate, a bottom cladding layer of silicon dioxide, a silicon core layer and a top cladding layer of silicon dioxide sequentially stacked from bottom to top, and the first-level asymmetric wavelength multiplexing and demultiplexing unit and the second-level symmetric wavelength multiplexing and demultiplexing unit are located in the core layer.

As illustrated in FIG. 3, the input waveguide 101 of the first-level asymmetric wavelength multiplexing and demultiplexing unit is located on the center position at the left side of the functional area 102 of the first-level asymmetric wavelength multiplexing and demultiplexing unit, the output waveguides 103, 104, 105 and 106 of the first-level asymmetric wavelength multiplexing and demultiplexing unit are equally distributed on the right side of the functional area 102 of the first-level asymmetric wavelength multiplexing and demultiplexing unit. The optical signals with 12 wavelengths λ₁ to λ₁₂ are input by the input waveguide 101 of the first-level asymmetric wavelength multiplexing and demultiplexing unit, the optical signals with 4 wavelengths λ₁ to λ₄ are output by the output waveguide 103 of the first-level asymmetric wavelength multiplexing and demultiplexing unit, the optical signals with wavelength λ₅ are output by the output waveguide 104 of the first-level asymmetric wavelength multiplexing and demultiplexing unit, the optical signals with wavelength λ₆ are output by the output waveguide 105 of the first-level asymmetric wavelength multiplexing and demultiplexing unit, and the optical signals with 6 wavelengths λ₇ to λ₁₂ are output by the output waveguide 106 of the first-level asymmetric wavelength multiplexing and demultiplexing unit, the output optical losses of the output waveguides 103, 104, 105 and 106 of the first-level asymmetric wavelength multiplexing and demultiplexing unit are different from each other. The functional area 102 of the first-level asymmetric wavelength multiplexing and demultiplexing unit is optimally designed based on DBS algorithm, and the FOM is defined as a MAX function with a minimum difference between the actual output optical losses and target output optical losses of the output waveguides 103, 104, 105 and 106 of the first-level asymmetric wavelength multiplexing and demultiplexing unit. The material of each sub-wavelength unit in the functional area 102 of the first-level asymmetric wavelength multiplexing and demultiplexing unit is silicon dioxide or silicon, corresponding to the silicon platform on the insulator. Firstly, the material types of the sub-wavelength units are randomly set; subsequently the size change of the FOM is calculated and compared by traversing each sub-wavelength unit, and the material types with larger FOMs are selectively retained; the material type of each sub-wavelength unit is determined by iterating and traversing all sub-wavelength elements repeatedly, and then the optimal structure of the functional area 102 of the first-level asymmetric wavelength multiplexing and demultiplexing unit is given to be 2×4 μm².

As illustrated in FIG. 4, the input waveguide 201 of the second-level symmetric wavelength multiplexing and demultiplexing unit is located on center position at the left side of the functional area 202 of the second-level symmetric wavelength multiplexing and demultiplexing unit, the output waveguides 203, 204, 205 and 206 of the second-level symmetric wavelength multiplexing and demultiplexing unit are equally distributed on the right side of the functional area 202 of the second-level symmetric wavelength multiplexing and demultiplexing unit. The optical signals with 4 wavelengths λ₁ to λ₄ are input by the input waveguide 201 of the second-level symmetric wavelength multiplexing and demultiplexing unit, the optical signals with wavelength λ₁ are output by the output waveguide 203 of the second-level symmetric wavelength multiplexing and demultiplexing unit, the optical signals with wavelength λ₂ are output by the output waveguide 204 of the second-level symmetric wavelength multiplexing and demultiplexing unit, the optical signals with wavelength λ₃ are output by the output waveguide 205 of the second-level symmetric wavelength multiplexing and demultiplexing unit, and the optical signals with wavelength λ₄ are output by the output waveguide 206 of the second-level symmetric wavelength multiplexing and demultiplexing unit, the output optical losses of the output waveguides 203, 204, 205 and 206 of the second-level symmetric wavelength multiplexing and demultiplexing unit are the same. The functional area 202 of the second-level symmetric wavelength multiplexing and demultiplexing unit is optimally designed based on DBS algorithm, and the FOM is defined as a MAX function with a minimum difference between the actual output optical losses and the target output optical losses of the output waveguide 203, 204, 205 and 206 of the second-level symmetric wavelength multiplexing and demultiplexing unit. The material of each sub-wavelength unit in the functional area 202 of the second-level symmetric wavelength multiplexing and demultiplexing unit is silicon dioxide or silicon, corresponding to the silicon platform on the insulator. Firstly, the material types of the sub-wavelength units are randomly set; subsequently the size change of the

FOM is calculated and compared by traversing each sub-wavelength unit, and the material types with larger FOMs are selectively retained; the material type of each sub-wavelength unit is determined by iterating and traversing all sub-wavelength elements repeatedly, and the optimal structure of the functional area of the second-level symmetric wavelength multiplexing and demultiplexing unit 002 is given to be 1.5×4 μm².

As illustrated in FIG. 5, the input waveguide 601 of the second-level symmetric wavelength multiplexing and demultiplexing unit is located on the center position at left side of the functional area 602 of the second-level symmetric wavelength multiplexing and demultiplexing unit 006, the output waveguides 603, 604, 605, 606, 607 and 608 of the second-level symmetric wavelength multiplexing and demultiplexing unit 006 are equally distributed on the right side of the functional area 602 of the second-level symmetric wavelength multiplexing and demultiplexing unit 006. The optical signals with 6 wavelengths _{λ7} to λ₁₂ are input by the input waveguide 601 of the second-level symmetric wavelength multiplexing and demultiplexing unit 006, the optical signals with wavelength λ₇ are output by the output waveguide 603 of the second-level symmetric wavelength multiplexing and demultiplexing unit 006, the optical signals with wavelength λ₈ are output by the output waveguide 604 of the second-level symmetric wavelength multiplexing and demultiplexing unit, the optical signals with wavelength λ₉ are output by the output waveguide 605 of the second-level symmetric wavelength multiplexing and demultiplexing unit 006, the optical signals with wavelength λ₁₀ are output by the output waveguide 606 of the second-level symmetric wavelength multiplexing and demultiplexing unit 006, the optical signals with wavelength λ₁₁ are output by the output waveguide 607 of the second-level symmetric wavelength multiplexing and demultiplexing unit 006, and the optical signals with wavelength λ₁₂ are output by the output waveguide 608 of the second-level symmetric wavelength multiplexing and demultiplexing unit 006, the output optical losses of the output waveguides 603 to 608 of the second-level symmetric wavelength multiplexing and demultiplexing unit 006 are the same. The functional area 602 of the second-level symmetric wavelength multiplexing and demultiplexing unit 006 is optimally designed based on DBS algorithm, and the FOM is defined as a MAX function with a minimum difference between the actual output optical losses and the target output optical losses of the output waveguide 603 to 608. The material of each sub-wavelength unit in the functional area 602 of the second-level symmetric wavelength multiplexing and demultiplexing unit 006 is silicon dioxide or silicon, corresponding to the silicon platform on the insulator. Firstly, the material types of the sub-wavelength units are randomly set; subsequently the size change of the FOM is calculated and compared by traversing each sub-wavelength unit, and the material types with larger FOMs are selectively retained; the material type of each sub-wavelength unit is determined by iterating and traversing all sub-wavelength elements repeatedly, and the optimal structure of the functional area of the second-level symmetric wavelength multiplexing and demultiplexing unit 006 is given to be 2×5 um².

The specific embodiment 2: the asymmetric wavelength multiplexing and demultiplexing chip for implementing non-uniform output for signal transmittances of 6 wavelengths in O+E band.

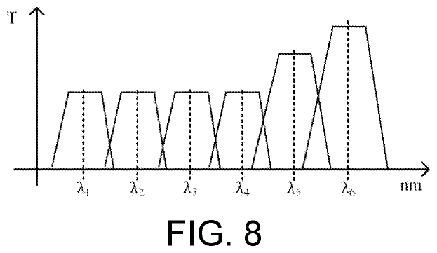

As illustrated in FIG. 7 and FIG. 8, as an extension of the present disclosure, this embodiment provides an asymmetric wavelength multiplexing and demultiplexing chip based on inverse design to implement the function of non-uniform output for transmittances of the 6 wavelengths λ₁ to λ₆. The wavelengths corresponding to λ₁ to λ₆ are respectively 1271 nm, 1291 nm, 1311 nm, 1331 nm, 1351 nm and 1371 nm.

The output spectrum diagram of the set of the optical signals with wavelengths λ₁, λ₂ . . . λ₆ is as illustrated in FIG. 8, as can be seen from FIG. 8, the output loss of the optical signals with four wavelengths λ₁ to λ₄ is 1.5 dB, and the output losses of the optical signals with wavelengths λ₅ and λ₆ are 0.6 dB and 0.3 dB respectively. A set of optical signals with wavelengths λ₁, λ₂ . . . λ₆ are divided into three sets of signals through wavelength division by the first-level asymmetric wavelength multiplexing and demultiplexing unit and then output. The optical signals with wavelengths λ₁, λ₂, λ₃, λ₄ are processed through wavelength division by the second-level symmetric wavelength multiplexing and demultiplexing unit and then output. The optical signals with wavelengths λ₅, λ₆ are output by one output waveguide of the first-level asymmetric wavelength multiplexing and demultiplexing unit directly. The specific structure of the asymmetric wavelength multiplexing and demultiplexing chip for implementing the non-uniform output for transmittance of the optical signals with wavelengths λ₁, λ₂ . . . λ₆ is as illustrated in FIG. 7.

The asymmetric wavelength multiplexing and demultiplexing chip for implementing the non-uniform output for transmittance of the optical signals with wavelengths λ₁, λ₂ . . . λ₆, adopts the same inverse design as Embodiment 1 to optimize the functional regions of the first-level asymmetric wavelength multiplexing and demultiplexing unit 001 and the second-level symmetric wavelength multiplexing and demultiplexing unit. The size of the first-level asymmetric wavelength multiplexing and demultiplexing unit 001 after optimization is 2×3 μm² and the size of the second-level symmetric wavelength multiplexing and demultiplexing unit 002 after optimization is 1.5×4 μm².

To sum up, the asymmetric wavelength multiplexing and demultiplexing chip based on inserve design provided in the present disclosure is capable of implementing all-band output with non-uniform power and unequal wavelength interval. The chip structure size is ultra-small, the performance is stable, and the crosstalk is relative low; and the wavelengths and channels have strong expansibility, which can implement the multiplexing of multi-type wavelengths. The materials for fabricating the asymmetric wavelength multiplexing and demultiplexing chip can be expanded to other materials (including but not limited to silicon on insulator, silicon on silicon, InP, GaAs, polymers, LN, diamond and chalcogenide series, and the like). Provided in the present disclosure is the wave-dividing function of 12 wavelengths, and based on the structure, the wave-combining function can also be implemented. The inverse design algorithm provided in the present disclosure is merely DBS algorithm, which can be extended to the inverse design algorithm based on semi-constrained algorithm, particle swarm optimization, level set method, density topology optimization, basic gradient algorithm, gradient descent algorithm and genetic algorithm, deep learning, and the like. The chip structures provided in the present disclosure are merely 12 and 6 wavelength layers, which can be extended from 12 wavelengths to more wavelength layers according to the present disclosure, so as to implement a relatively diversified effect of asymmetric wavelength multiplexing and demultiplexing. The present disclosure has the advantages of simple design, mature manufacturing process and compatibility with CMOS manufacturing process, and has wide application prospect in optical communication WDM system.

The above embodiments are merely used to illustrate the technical solutions of the

present disclosure rather than limit the present disclosure. Although the present disclosure is described in detail with reference to preferable embodiments, it should be understood for ordinary people who skilled in the art that the technical solutions of the present disclosure may be modified or equivalent replaced without deviating from the spirit and scope of the technical solutions of the present disclosure.

1. An asymmetric wavelength multiplexing and demultiplexing chip based on inverse design, wherein, comprising:
a first-level asymmetric wavelength multiplexing and demultiplexing unit, whose input waveguide is accessed to a set of optical signals with different wavelengths, whose N output waveguides respectively output a set of optical signals with different wavelengths but same transmittance, and whose M output waveguides respectively output one of M optical signals with different transmittances, wherein both N and M are integers greater than or equal to 1, and
N second-level symmetric wavelength multiplexing and demultiplexing units, with an input waveguide of each second-level symmetric wavelength multiplexing and demultiplexing unit respectively receiving a set of optical signals with different wavelengths but same transmittance, and an output waveguide of each second-level symmetric wavelength multiplexing and demultiplexing unit respectively outputting a set of optical signals with different wavelengths but same transmittance;
wherein all functional regions of the first-level asymmetric wavelength multiplexing and demultiplexing unit and N second-level symmetric wavelength multiplexing and demultiplexing units are optimized by adopting the inverse design, specifically: a FOM function is established, based on a target of minimizing a difference between an actual output optical loss and a target output optical loss of each output waveguide in wavelength multiplexing and demultiplexing units; all sub-wavelength units in the functional regions are traversed to select a material type of the sub-wavelength unit that maximizes a value for the FOM function, and the actual output optical loss of the output waveguide of the wavelength multiplexing and demultiplexing unit is obtained by calculating a ratio of the transmittances of the output waveguide and the input waveguide to the optical signal with same wavelength.

2. The asymmetric wavelength multiplexing and demultiplexing chip based on inverse design according to claim 1, wherein one of the M output waveguides in the first-level asymmetric wavelength multiplexing and demultiplexing unit is accessed to a N+1-th second-level symmetric wavelength multiplexing and demultiplexing unit, at least two of the M optical signals with different transmittances are transmitted to an input waveguide of the N+1-th second-level symmetric wavelength multiplexing and demultiplexing unit through one of the M output waveguides of the first-level asymmetric wavelength multiplexing and demultiplexing unit, and at least two of the M optical signals with different transmittances are output through wavelength division by an output waveguide of the N+1-th second-level symmetric wavelength multiplexing and demultiplexing unit.

3. The asymmetric wavelength multiplexing and demultiplexing chip based on inverse design according to claim 2, wherein at least one of the N output waveguides of the first-level asymmetric wavelength multiplexing and demultiplexing unit is accessed to an input waveguide of third-level symmetric wavelength multiplexing and demultiplexing units, part of the set of optical signals with different wavelengths but same transmittance output by one of the N output waveguides of the first-level asymmetric wavelength multiplexing and demultiplexing unit are transmitted to one third-level symmetric wavelength multiplexing and demultiplexing unit, and part of the set of optical signals with different wavelengths but same transmittance are output by the third-level symmetric wavelength multiplexing and demultiplexing unit through wavelength division.

4. The asymmetric wavelength multiplexing and demultiplexing chip based on inverse design according to claim 2, wherein a FOM function is established, based on a target of minimizing a difference between an actual output optical loss and a target output optical loss of each output waveguide of the first-level asymmetric wavelength multiplexing and demultiplexing unit, that is:
$$FOM = FOM ( {O}_{1} ) + … + F OM ( {O}_{m + p} ) + … + F OM ( {O}_{m + p + q + 1} ) + F OM ( {O}_{m + p + q + 2} ) + … F OM ( {O}_{m + p + q + r} ) + F OM ( {O}_{m + p + q + s + 1} ) + … + F OM ( {O}_{m + p + q + s + w} ) ,$$
$$FOM ( {O}_{1} ) = \frac{1}{\vert \frac{{T}_{{λ}_{1} , {O}_{1}}}{{T}_{{λ}_{1} , in}} - {IL}_{{O}_{1}} \vert} + \frac{1}{\vert \frac{{T}_{{λ}_{2} , {O}_{1}}}{{T}_{{λ}_{2} , in}} - {IL}_{{O}_{1}} \vert} + … + \frac{1}{\vert \frac{{T}_{{λ}_{m} , {O}_{1}}}{{T}_{{λ}_{m} , in}} - {IL}_{{O}_{1}} \vert} ,$$
$$FOM ( {O}_{m + p} ) = \frac{1}{\vert \frac{{T}_{{λ}_{m + p} , {O}_{m + p}}}{{T}_{{λ}_{m + p} , in}} - {IL}_{{O}_{m + p}} \vert} + \frac{1}{\vert \frac{{T}_{{λ}_{m + p + 1} , {O}_{m + p}}}{{T}_{{λ}_{m + p + 1} , in}} - {IL}_{{O}_{m + p}} \vert} + … + \frac{1}{\vert \frac{{T}_{{λ}_{m + p + q} , {O}_{m + p}}}{{T}_{{λ}_{m + p + q} , in}} - {IL}_{{O}_{m + p}} \vert} ,$$
$$FOM ( {O}_{m + p + q + 1} ) = \frac{1}{\vert \frac{{T}_{{λ}_{m + p + q + 1} , {O}_{m + p + q + 1}}}{{T}_{{λ}_{m + p + q + 1} , in}} - {IL}_{{O}_{m + p + q + 1}} \vert} ,$$
$$FOM ( {O}_{m + p + q + 2} ) = \frac{1}{\vert \frac{{T}_{{λ}_{m + p + q + 2} , {O}_{m + p + q + 2}}}{{T}_{{λ}_{m + p + q + 2} , in}} - {IL}_{{O}_{m + p + q + 2}} \vert} ,$$
$$FOM ( {O}_{m + p + q + r} ) = \frac{1}{\vert \frac{{T}_{{λ}_{m + p + q + r} , {O}_{m + p + q + r}}}{{T}_{{λ}_{m + p + q + r} , in}} - {IL}_{{O}_{m + p + q + r}} \vert} + \frac{1}{\vert \frac{{T}_{{λ}_{m + p + q + r + 1} , {O}_{m + p + q + r}}}{{T}_{{λ}_{m + p + q + r + 1} , in}} - {IL}_{{O}_{m + p + q + r}} \vert} + … + \frac{1}{\vert \frac{{T}_{{λ}_{m + p + q + s} , {O}_{m + p + q + r}}}{{T}_{{λ}_{m + p + q + s} , in}} - {IL}_{{O}_{m + p + q + r}} \vert} ,$$
$$FOM ( {O}_{m + p + q + s + 1} ) = \frac{1}{\vert \frac{{T}_{{λ}_{m + p + q + s + 1} , {O}_{m + p + q + s + 1}}}{{T}_{{λ}_{m + p + q + s + 1} , in}} - {IL}_{{O}_{m + p + q + s + 1}} \vert} + \frac{1}{\vert \frac{{T}_{{λ}_{m + p + q + s + 2} , {O}_{m + p + q + s + 1}}}{{T}_{{λ}_{m + p + q + s + 2} , in}} - {IL}_{{O}_{m + p + q + s + 1}} \vert} + … + \frac{1}{\vert \frac{{T}_{{λ}_{m + p + q + s + t} + q , {O}_{m + p + q + s + 1}}}{{T}_{{λ}_{m + p + q + s + t} , in}} - {IL}_{{O}_{m + p + q + s + 1}} \vert} ,$$
$$FOM ( {O}_{m + p + q + s + w} ) = \frac{1}{\vert \frac{{T}_{{λ}_{m + p + q + s + t + w} , {O}_{m + p + q + s + w}}}{{T}_{{λ}_{m + p + q + s + w} , in}} - {IL}_{{O}_{m + p + q + s + w}} \vert} + \frac{1}{\vert \frac{{T}_{{λ}_{m + p + q + s + t + w + 1} , {O}_{m + p + q + s + w}}}{{T}_{{λ}_{m + p + q + s + w + 1} , in}} - {IL}_{{O}_{m + p + q + s + w}} \vert} + … + \frac{1}{\vert \frac{{T}_{{λ}_{n - v} , {O}_{m + p + q + s + w}}}{{T}_{{λ}_{n - v} , in}} - {IL}_{{O}_{m + p + q + s + w}} \vert} + \frac{1}{\vert \frac{{T}_{{λ}_{n - v + 1} , {O}_{m + p + q + s + w}}}{{T}_{{λ}_{n - v + 1} , in}} - {IL}_{{O}_{m + p + q + s + w}} \vert} … + \frac{1}{\vert \frac{{T}_{{λ}_{n} , {O}_{m + p + q + s + w}}}{{T}_{{λ}_{n} , in}} - {IL}_{{O}_{m + p + q + s + w}} \vert}$$
where FOM(O₁) represents an evaluation function for transmittances T_{λ}_{₁}_{,O}_{₁}, T_{λ}_{₂}_{,O}_{₁} . . . T_{λ}_{ₘ}_{,O}_{₁} of a first output waveguide O₁ of the first-level asymmetric wavelength multiplexing and demultiplexing unit to a set of optical signals with wavelengths λ₁, λ₂ . . . λₘ, T_{λ}_{₁}_{,in}, T_{λ}_{₂}_{,in} . . . T_{λ}_{ₘ}_{,in} represent transmittances of input waveguides of the first-level asymmetric wavelength multiplexing and demultiplexing unit to the set of optical signals with wavelengths λ₁, λ₂ . . . λₘ, IL_{O}_{₁} represents a target output optical loss of the first output waveguide O₁ of the first-level asymmetric wavelength multiplexing and demultiplexing unit; FOM(Oₘ₊ₚ) represents an evaluation function for transmittances T_{λ}_{ₘ₊ₚ}_{,O}_{ₘ₊ₚ}, T_{λ}_{ₘ₊ₚ₊₁}_{,O}_{ₘ₊ₚ} . . . T_{λ}_{_{m+p+q}}_{,O}_{ₘ₊ₚ} of an m+p-th output waveguide Oₘ₊ₚ of the first-level asymmetric wavelength multiplexing and demultiplexing unit to a set of optical signals with wavelengths λₘ₊ₚ, λₘ₊ₚ₊₁ . . . λ_{m+p+q}, T_{λ}_{ₘ₊ₚ}_{,in}, T_{λ}_{ₘ₊ₚ₊₁}_{,in} . . . T_{λ}_{_{m+p+q}}_{,in} represent transmittances of the input waveguides of the first-level asymmetric wavelength multiplexing and demultiplexing unit to the set of optical signals with wavelengths λₘ₊ₚ, λₘ₊ₚ₊₁ . . . λ_{m+p+q}, IL_{O}_{ₘ₊ₚ} represents a target output optical loss of the m+p-th output waveguide Oₘ₊ₚ of the first-level asymmetric wavelength multiplexing and demultiplexing unit; FOM(O_{m+p+q+1}) represents an evaluation function for a transmittance T_{λ}_{_{m+p+q+1}}_{,O}_{_{m+p+q+1}} of an m+p+q+1-th output waveguide O_{m+p+q+1} of the first-level asymmetric wavelength multiplexing and demultiplexing unit to optical signals with a wavelength λ_{m+p+q+1}, T_{λ}_{_{m+p+q+1}}_{,in} in represents a transmittance of the input waveguide of the first-level asymmetric wavelength multiplexing and demultiplexing unit to the optical signals with the wavelength λ_{m+p+q+1}, IL_{O}_{_{m+p+q+1}} represents a target output optical loss of the m+p+q+1-th output waveguide O_{m+p+q+1} of the first-level asymmetric wavelength multiplexing and demultiplexing unit; FOM(O_{m+p+q+2}) represents an evaluation function for a transmittance T_{λ}_{_{m+p+q+2}}_{,O}_{_{m+p+q+2}} of an m+p+q+2-th output waveguide O_{m+p+q+2} of the first-level asymmetric wavelength multiplexing and demultiplexing unit to optical signals with a wavelength λ_{m+p+q+2}, T_{λ}_{_{m+p+q+2}}_{,in} represents a transmittance of the input waveguide of the first-level m+p+q asymmetric wavelength multiplexing and demultiplexing unit to the optical signals with the wavelength λ_{m+p+q+2}, IL_{O}_{_{m+p+q+2}} represents a target output optical loss of the m+p+q+2-th output waveguide O_{m+p+q+2} of the first-level asymmetric wavelength multiplexing and demultiplexing unit; FOM(O_{m+p+q+r}) represents an evaluation function for transmittances T_{λ}_{_{m+p+q+r}}_{,O}_{_{m+p+q+r}}, T_{λ}_{_{m+p+q+r+1}}_{,O}_{_{m+p+q+r}} . . . T_{λ}_{_{m+p+q+s}}_{,O}_{_{m+p+q+r}} of an m+p+q+r-th output waveguide O_{m+p+q+r} of the first-level asymmetric wavelength multiplexing and demultiplexing unit to a set of optical signals with wavelengths λ_{m+p+q+r}, λ_{m+p+q+r+1} . . . λ_{m+p+q+s}, T_{λ}_{_{m+p+q+r}}_{,in} , T_{λ}_{_{m+p+q+r+1}}_{,in} . . . T_{λ}_{_{m+p+q+s}}_{,in} represent transmittances of the input waveguide of the first-level asymmetric wavelength multiplexing and demultiplexing unit to the set of optical signals with wavelengths λ_{m+p+q+r}, λ_{m+p+q+r+1} . . . λ_{m+p+q+s}, IL_{O}_{_{m+p+q+r}} represents a target output optical loss of the m+p+q+r-th output waveguide O_{m+p+q+r} of the first-level asymmetric wavelength multiplexing and demultiplexing unit; FOM(O_{m+p+q+s+1}) represents an evaluation function for transmittances T_{λ}_{_{m+p+q+s+1}}_{,O}_{_{m+p+q+s+1}}, T_{λ}_{_{m+p+q+s+2}}_{,O}_{_{m+p+q+s+1}} . . . T_{λ}_{_{m+p+q+s+t}}_{,O}_{_{m+p+q+s+1}} of an m+p+q+s+1-th output waveguide O_{m+p+q+s+1} of the first-level asymmetric wavelength multiplexing and demultiplexing unit to a set of optical signals with wavelengths λ_{m+p+q+s+1}, λ_{m+p+q+s+2} . . . λ_{m+p+q+s+t}, T_{λ}_{_{, m+p+q+s+1}}_{,in}, T_{λ}_{_{m+p+q+s+2}}_{,in} . . . T_{λ}_{_{m+p+q+s+t}}_{,in} represent transmittances of the input waveguide of the first-level asymmetric wavelength multiplexing and demultiplexing unit to the set of optical signals with wavelengths λ_{m+p+q+s+1}, λ_{m+p+q+s+2} . . . λ_{m+p+q+s+t}, IL_{O}_{_{m+p+q+s+1}} represents a target output optical loss of the m+p+q+s+1-th output waveguide O_{m+p+q+s+1} of the first-level asymmetric wavelength multiplexing and demultiplexing unit; FOM(O_{m+p+q+s+w}) represents an evaluation function for transmittances T_{λ}_{_{m+p+q+s+t+w}}_{,O}_{_{m+p+q+s+w}}, T_{λ}_{_{m+p+q+s+t+w}}_{,O}_{_{m+p+q+s+w}} . . . T_{λ}_{_{n−v}}_{,O}_{_{m+p+q+s+}}, T_{λ}_{_{n−v+1}}_{,O}_{_{m+p+q+s+w}} . . . T_{λ}_{ₙ}_{,O}_{_{m+p+q+s+w}} of an m+p+q+s+w-th output waveguide O_{m+p+q+s+w} of the first-level asymmetric wavelength multiplexing and demultiplexing unit to a set of optical signals with wavelengths λ_{m+p+q+s+t+w}, λ_{m+p+q+s+t+w+1} . . . λₙ₋ᵥ, λₙ₋ᵥ₊₁ . . . λₙ, T_{λ}_{_{m+p+q+s+t+w}}_{,in} , T_{λ}_{_{m+p+q+s+t+w+1}}_{,in} . . . T_{λ}_{_{n−v}}_{,in}, T_{λ}_{_{n−v+1}}_{,in} . . . T_{λ}_{ₙ}_{,in} represent transmittances of the input waveguide of the first-level asymmetric wavelength multiplexing and demultiplexing unit to the set of optical signals with wavelengths λ_{m+p+q+s+t+w+}, λ_{m+p+q+s+t+w+1} . . . λₙ₋ᵥ, λₙ₋ᵥ₊₁ . . . λₙ, IL_{O}_{_{m+p+q+s+w}} represents a target output optical loss of the m+p+q+s+w-th output waveguide O_{m+p+q+s+w} of the first-level asymmetric wavelength multiplexing and demultiplexing unit, and c, m, p, q, r, s, t, w, and n are positive integers that increase in sequence.

5. The asymmetric wavelength multiplexing and demultiplexing chip based on inverse design according to claim 4, wherein values for c, m, p, q, r, s, t, w and n are adjusted according to intervals of output wavelengths of the asymmetric wavelength multiplexing and demultiplexing chip.

6. The asymmetric wavelength multiplexing and demultiplexing chip based on inverse design according to claim 1, wherein the first-level asymmetric wavelength multiplexing and demultiplexing unit is accessed with the input waveguide of the second-level symmetric wavelength multiplexing and demultiplexing unit through an S-shaped curved waveguide.

7. The asymmetric wavelength multiplexing and demultiplexing chip based on inverse design according to claim 1, wherein the input waveguides of the first-level asymmetric wavelength multiplexing and demultiplexing unit are all arranged at center positions on one side of the functional regions, and the output waveguides of the first-level asymmetric wavelength multiplexing and demultiplexing unit are uniformly distributed on another side of the functional regions; the input waveguides of the second-level symmetric wavelength multiplexing and demultiplexing unit are all arranged at center positions on one side of the functional regions, and the output waveguides of the second-level symmetric wavelength multiplexing and demultiplexing unit are uniformly distributed on another side of the functional regions.

8. The asymmetric wavelength multiplexing and demultiplexing chip based on inverse design according to claim 1, wherein the asymmetric wavelength multiplexing and demultiplexing chip is prepared by a semiconductor process, based on one of platforms of silicon on insulator, silicon dioxide on silicon, InP, GaAs, polymer, LN, diamond and chalcogenide system.

9. The asymmetric wavelength multiplexing and demultiplexing chip based on inverse design according to claim 2, wherein the first-level asymmetric wavelength multiplexing and demultiplexing unit is accessed with the input waveguide of the second-level symmetric wavelength multiplexing and demultiplexing unit through an S-shaped curved waveguide.

10. The asymmetric wavelength multiplexing and demultiplexing chip based on inverse design according to claim 3, wherein the first-level asymmetric wavelength multiplexing and demultiplexing unit is accessed with the input waveguide of the second-level symmetric wavelength multiplexing and demultiplexing unit through an S-shaped curved waveguide.

11. The asymmetric wavelength multiplexing and demultiplexing chip based on inverse design according to claim 4, wherein the first-level asymmetric wavelength multiplexing and demultiplexing unit is accessed with the input waveguide of the second-level symmetric wavelength multiplexing and demultiplexing unit through an S-shaped curved waveguide.

12. The asymmetric wavelength multiplexing and demultiplexing chip based on inverse design according to claim 5, wherein the first-level asymmetric wavelength multiplexing and demultiplexing unit is accessed with the input waveguide of the second-level symmetric wavelength multiplexing and demultiplexing unit through an S-shaped curved waveguide.

13. The asymmetric wavelength multiplexing and demultiplexing chip based on inverse design according to claim 2, wherein the input waveguides of the first-level asymmetric wavelength multiplexing and demultiplexing unit are all arranged at center positions on one side of the functional regions, and the output waveguides of the first-level asymmetric wavelength multiplexing and demultiplexing unit are uniformly distributed on another side of the functional regions; the input waveguides of the second-level symmetric wavelength multiplexing and demultiplexing unit are all arranged at center positions on one side of the functional regions, and the output waveguides of the second-level symmetric wavelength multiplexing and demultiplexing unit are uniformly distributed on another side of the functional regions.

14. The asymmetric wavelength multiplexing and demultiplexing chip based on inverse design according to claim 3, wherein the input waveguides of the first-level asymmetric wavelength multiplexing and demultiplexing unit are all arranged at center positions on one side of the functional regions, and the output waveguides of the first-level asymmetric wavelength multiplexing and demultiplexing unit are uniformly distributed on another side of the functional regions; the input waveguides of the second-level symmetric wavelength multiplexing and demultiplexing unit are all arranged at center positions on one side of the functional regions, and the output waveguides of the second-level symmetric wavelength multiplexing and demultiplexing unit are uniformly distributed on another side of the functional regions.

15. The asymmetric wavelength multiplexing and demultiplexing chip based on inverse design according to claim 4, wherein the input waveguides of the first-level asymmetric wavelength multiplexing and demultiplexing unit are all arranged at center positions on one side of the functional regions, and the output waveguides of the first-level asymmetric wavelength multiplexing and demultiplexing unit are uniformly distributed on another side of the functional regions; the input waveguides of the second-level symmetric wavelength multiplexing and demultiplexing unit are all arranged at center positions on one side of the functional regions, and the output waveguides of the second-level symmetric wavelength multiplexing and demultiplexing unit are uniformly distributed on another side of the functional regions.

16. The asymmetric wavelength multiplexing and demultiplexing chip based on inverse design according to claim 5, wherein the input waveguides of the first-level asymmetric wavelength multiplexing and demultiplexing unit are all arranged at center positions on one side of the functional regions, and the output waveguides of the first-level asymmetric wavelength multiplexing and demultiplexing unit are uniformly distributed on another side of the functional regions; the input waveguides of the second-level symmetric wavelength multiplexing and demultiplexing unit are all arranged at center positions on one side of the functional regions, and the output waveguides of the second-level symmetric wavelength multiplexing and demultiplexing unit are uniformly distributed on another side of the functional regions.

17. The asymmetric wavelength multiplexing and demultiplexing chip based on inverse design according to claim 2, wherein the asymmetric wavelength multiplexing and demultiplexing chip is prepared by a semiconductor process, based on one of platforms of silicon on insulator, silicon dioxide on silicon, InP, GaAs, polymer, LN, diamond and chalcogenide system.

18. The asymmetric wavelength multiplexing and demultiplexing chip based on inverse design according to claim 3, wherein the asymmetric wavelength multiplexing and demultiplexing chip is prepared by a semiconductor process, based on one of platforms of silicon on insulator, silicon dioxide on silicon, InP, GaAs, polymer, LN, diamond and chalcogenide system.

19. The asymmetric wavelength multiplexing and demultiplexing chip based on inverse design according to claim 4, wherein the asymmetric wavelength multiplexing and demultiplexing chip is prepared by a semiconductor process, based on one of platforms of silicon on insulator, silicon dioxide on silicon, InP, GaAs, polymer, LN, diamond and chalcogenide system.

20. The asymmetric wavelength multiplexing and demultiplexing chip based on inverse design according to claim 5, wherein the asymmetric wavelength multiplexing and demultiplexing chip is prepared by a semiconductor process, based on one of platforms of silicon on insulator, silicon dioxide on silicon, InP, GaAs, polymer, LN, diamond and chalcogenide system.
